(19) United States
(12) Patent Application Publication
(10) Pub. No.: US 2011/0037696 A1
(43) Pub. Date: Feb. 17, 2011

(54) WHEEL MOUSE

(75) Inventor: Shou-Shen Tang, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/574,015

(22) Filed: Oct. 6, 2009

(30) Foreign Application Priority Data
Aug. 14, 2009 (TW) 098127365

(51) Int. Cl. G06F 3/033

(52) U.S. Cl. 345/163

(57) ABSTRACT

A wheel mouse includes a base, an encoder, a wheel supporting frame, a wheel swing member, an encoder holder, a circuit board, and a plurality of tilt switches. The wheel supporting frame has a receptacle. The encoder holder is connected with the wheel swing member. The encoder is accommodated within the receptacle of the wheel supporting frame, so that the height of the wheel mouse is reduced.

### FIELD OF THE INVENTION

The present invention relates to a wheel mouse, and more particularly to a tilt wheel mouse.

### BACKGROUND OF THE INVENTION

A mouse device is an important bridge between a computer system and a user. In addition to the basic functions of controlling cursor movement, the mouse device is developed to execute extended functions.

Generally, commercially available wheel mice are usually classified into two major types. By rotating a scroll wheel of the first type wheel mouse, the third-axial rotating function is activated to permit for a single axial (e.g. either horizontal or vertical) scrolling operation of the computer screen. For most wheel mice, the single axial scrolling operation is set to be a vertical scrolling operation of the computer screen. The second type wheel mouse is also referred as a tilt wheel mouse. In addition to the third-axial rotating function by rotating a scroll wheel, the scroll wheel of the tilt wheel mouse may be tilted toward the left side or the right side to control a four axial scrolling operation of the computer screen. That is, the tilt wheel mouse may control both horizontal scroll movement and vertical scroll movement of the images shown on the computer screen.

Hereinafter, the configurations of a conventional tilt wheel mouse will be illustrated in more details with reference to FIG. 1. FIG. 1 is a schematic perspective view illustrating the internal portion of a conventional tilt wheel mouse. The tilt wheel mouse 1 comprises a base 10, a first supporting element 11, a second supporting element 12, a left-button switch 13, a right-button switch 14, a wheel switch 15, a left-side tilt switch 16, a right-side tilt switch (not shown), a scroll wheel 17, a wheel shaft 171, an encoder 18 and a wheel swing member 19. The first supporting element 11 and the second supporting element 12 are disposed on the base 10 for supporting the wheel swing member 19. The wheel shaft 171 is supported on the wheel swing member 19 such that the scroll wheel 17 is partially accommodated within the wheel swing member 19. The first supporting element 11 and the second supporting element 12 are respectively arranged at the front end and the rear end of the scroll wheel 17. As a result, the scroll wheel 17 may be tilted toward the left or right side. The left-button switch 13, the right-button switch 14, the wheel switch 15, the left-side tilt switch 16 and the right-side tilt switch (not shown) are disposed on the base 10. When the left button, the right button or the triggering shaft 192 are depressed, the left-button switch 13, the right-button switch 14 and the wheel switch 15 are respectively triggered to generate corresponding switching signals. When the scroll wheel 17 is tilted toward the left side or the right side, the left-side tilt switch 16 and the right-side tilt switch are respectively triggered to generate corresponding switching signals.

A first end of the wheel swing member 19 is supported on the first supporting element 11. A second end of the wheel swing member 19 is formed as the triggering shaft 192, which is disposed above the wheel switch 15. In a case that the scroll wheel 17 is pressed down, the triggering shaft 192 of the wheel swing member 19 is moved downwardly to trigger the wheel switch 15, thereby generating a switching signal. Furthermore, a receptacle 191 is formed in the wheel swing member 19 for accommodating the encoder 18.

The internal configurations and the operating principles of the conventional tilt wheel mouse 2 have been described above. Recently, the trend of designing a wheel mouse is toward a slim type mouse. In views of slimness, the space within the mouse case needs to be as small as possible while maintaining the original functions of the wheel mouse. In other words, the length and the height of the wheel mouse need to be reduced. As can be seen from the inner configurations of the wheel mouse of FIG. 1, it is possible to reduce the length of the wheel mouse. Since the encoder 18 of the conventional wheel mouse 1 is disposed beside the scroll wheel 17, the right button on the mouse case is very close to the encoder 18. In a case that the mouse case of the conventional wheel mouse 1 is reduced, the distance between the right button and the encoder 18 is reduced, so that the right button and the encoder 18 are possibly contacted with each other. When the right button is depressed, the encoder 18 is readily touched by the depressed right button, and thus the right button fails to be continuously depressed to trigger the right-button switch. In other words, the function of the right button of the conventional wheel mouse 1 is lost.

Therefore, there is a need of providing a wheel mouse having the functions of a slim wheel mouse and a tilt wheel mouse.

### SUMMARY OF THE INVENTION

It is an object of the present invention to provide a wheel mouse having the functions of a slim wheel mouse and a tilt wheel mouse.

In accordance with an aspect of the present invention, there is provided a wheel mouse. The wheel mouse includes a base, a circuit board, a first tilt switch, an encoder, a wheel supporting frame, a wheel swing member, and an encoder holder. The base has a first supporting element and a second supporting element. The circuit board is disposed on the base. The first tilt switch is disposed on a first side of the circuit board. The encoder has an encoder perforation. The wheel supporting frame includes a rotating shaft and a receptacle. The rotating shaft penetrates through the encoder perforation. The encoder is accommodated within the receptacle. The wheel swing member is disposed on the base for accommodating the wheel supporting frame and permitted to be swung with respect to the base. A first end of the wheel swing member is connected to the first supporting element. A second end of the wheel swing member is connected to the second supporting element. The wheel swing member has a first extension arm arranged above the first tilt switch. The encoder holder is connected to the wheel swing member for fixing the encoder. When the wheel swing member is swung with respect to the base and the first tilt switch is touched by the first extension arm, the first tilt switch is triggered to generate a first tilt signal to the circuit board.

In an embodiment, the wheel mouse further includes a scroll wheel, which is disposed on an outer periphery of the wheel supporting frame. The wheel supporting frame is synchronously rotated upon rotation of the scroll wheel.

In an embodiment, the encoder holder includes a connecting part, and the encoder holder is connected with the wheel swing member through the connecting part.

In an embodiment, the encoder holder and the wheel swing member are integrally formed.

In an embodiment, the wheel mouse further includes a signal wire. A first end of the signal wire is connected to the encoder. A second end of the signal wire is connected to the circuit board. A wheel rotation signal generated when the wheel supporting frame is transmitted from the encoder to the circuit board through the signal wire.

In an embodiment, the encoder holder further includes an encoder holder hole. The signal wire penetrates through the encoder holder hole such that the second end of the signal wire is connected to the circuit board.

In an embodiment, the wheel mouse further includes a second tilt switch and a wheel switch. The wheel switch is disposed on the circuit board. The second tilt switch disposed on a second side of the circuit board.

In an embodiment, the wheel swing member further includes a second extension arm and a protrusion. The second extension arm is arranged above the second tilt switch. When the wheel swing member is swung with respect to the base and the second tilt switch is touched by the second extension arm, the second tilt switch is triggered to generate a second tilt signal to the circuit board. The protrusion is arranged above the wheel switch. When the wheel swing member is moved downwardly toward the base and the wheel switch is touched by the protrusion, the wheel switch is triggered to generate a wheel button signal to the circuit board.

In an embodiment, the circuit board further includes a first board hole and a second board hole. The first supporting element penetrates through the first board hole. The second supporting element penetrates through the second board hole. When the wheel swing member is moved downwardly toward the base, the wheel swing member partially penetrates through the second board hole.

In an embodiment, the first supporting element has a perforation. The second supporting element has a notch. The first end of the wheel swing member penetrates through the perforation of the first supporting element and the second end of the wheel swing member is partially received in the notch of the second supporting element, so that the wheel supporting frame is permitted to be swung with respect to the base.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the internal portion of a conventional tilt wheel mouse;

FIG. 2 is a schematic perspective view illustrating the outward appearance of a wheel mouse according to the present invention;

FIG. 3 is a schematic exploded view illustrating the internal portion of the wheel mouse according to a first embodiment of the present invention;

FIG. 4 is a schematic assembled view illustrating the wheel mouse of FIG. 3;

FIG. 5 is a schematic assembled view illustrating the wheel mouse of FIG. 3 that is taken from another viewpoint; and

FIG. 6 is a schematic exploded view illustrating the internal portion of the wheel mouse according to a second embodiment of the present invention.

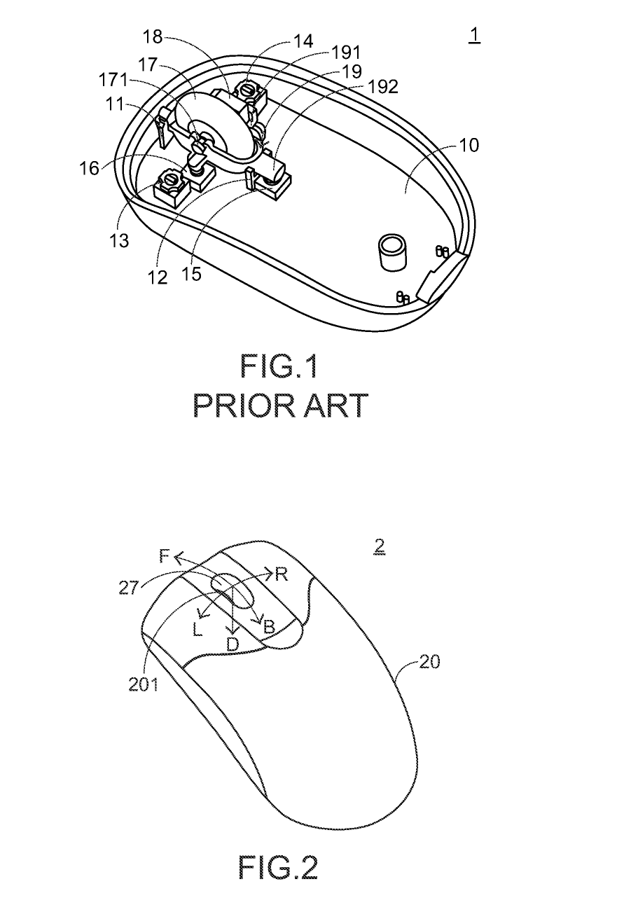

### DETAILED DESCRIPTION OF THE PREFERRED EMBODIMENT

The present invention provides a wheel mouse. FIG. 2 is a schematic perspective view illustrating the outward appearance of a wheel mouse according to the present invention. As shown in FIG. 2, the wheel mouse 2 comprises a case 20 and a scroll wheel 27. The scroll wheel 27 is positioned within an opening 201 of the case 20 and partially protruded from the outer surface of the case 20, so that the scroll wheel 27 can be manipulated by a user. By rotating the scroll wheel 27 of the wheel mouse 2 forwardly (in the direction F) or backwardly (in the direction B), the image shown on the computer screen is vertically scrolled. By tilting the scroll wheel 27 of the wheel mouse 2 toward the right side (in the direction R) or the left side (in the direction L), the image shown on the computer screen is horizontally scrolled. In addition, when the scroll wheel 27 is pressed down (in the direction D), the wheel mouse 2 executes a wheel button function.

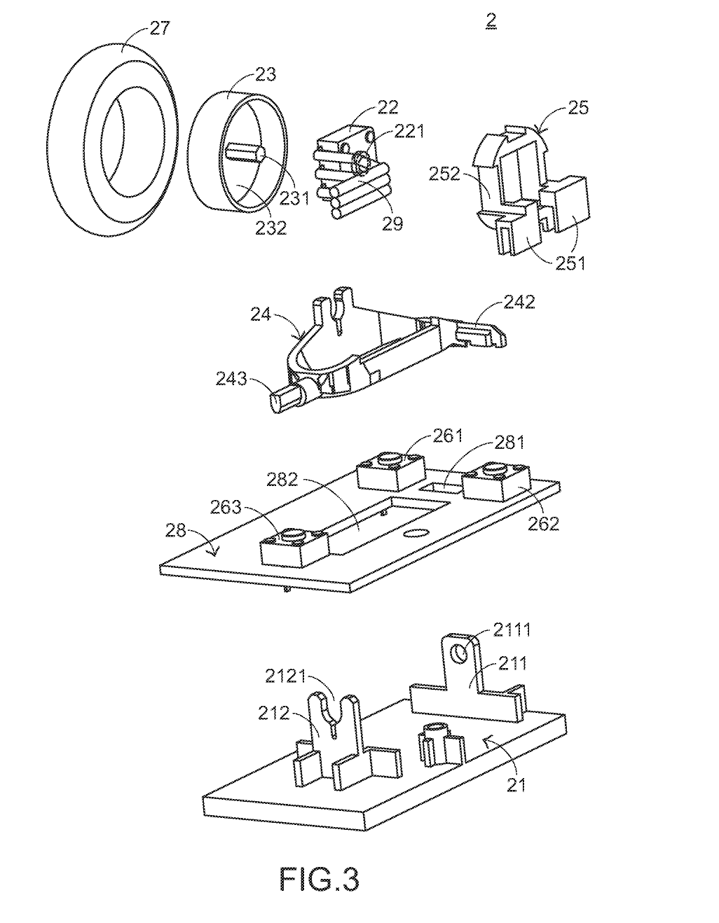

FIG. 3 is a schematic exploded view illustrating the internal portion of the wheel mouse according to a first embodiment of the present invention. As shown in FIG. 3, the wheel mouse 2 comprises a base 21, an encoder 22, a wheel supporting frame 23, a scroll wheel 27, a wheel swing member 24, an encoder holder 25, a circuit board 28, a first tilt switch 261, a second tilt switch 262, a wheel switch 263 and a signal wire 29. The base 21 further includes a first supporting element 211 and a second supporting element 212. The encoder holder 25 comprises a connecting part 251 and a encoder holder hole 252.

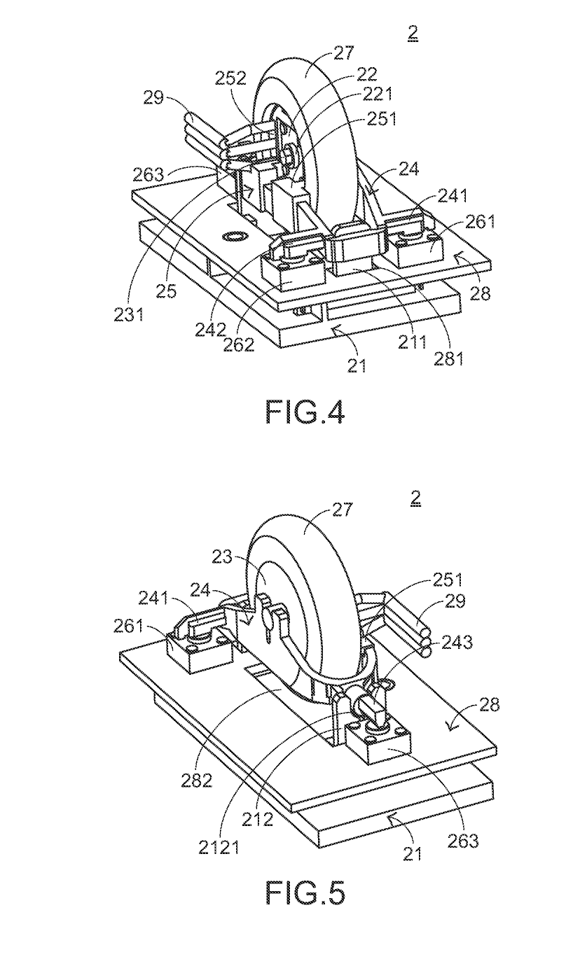

As shown in FIG. 3, the circuit board 28 further includes a first board hole 281 and a second board hole 282. The first supporting element 211 penetrates through the first board hole 281. The second supporting element 212 penetrates through the second board hole 282. The first tilt switch 261 and the second tilt switch 262 are disposed at a first side and a second side of the circuit board 28, respectively. The wheel switch 263 is also mounted on the circuit board 28. The encoder 22 has an encoder perforation 221. The wheel supporting frame 23 comprises a rotating shaft 231 and a receptacle 232. The rotating shaft 231 penetrates through the encoder perforation 221. The receptacle 232 is used for accommodating the encoder 22. The scroll wheel 27 is disposed on an outer periphery of the wheel supporting frame 23. Upon rotation of the scroll wheel 27, the wheel supporting frame 23 is synchronously rotated. The wheel supporting frame 23 is accommodated within the wheel swing member 24. The wheel swing member 24 further includes a first extension arm 241 (see FIG. 4), a second extension arm 242 and a protrusion 243.

Hereinafter, a process of assembling the wheel mouse 2 will be illustrated with reference to FIGS. 4 and 5. FIG. 4 is a schematic assembled view illustrating the wheel mouse of FIG. 3. FIG. 5 is a schematic assembled view illustrating the wheel mouse of FIG. 3 that is taken from another viewpoint. The circuit board 28 is disposed on the base 21. The first supporting element 211 of the base 21 penetrates through the first board hole 281. The second supporting element 212 penetrates through the second board hole 282. A first end of the wheel swing member 24 penetrates through a perforation 2111 of the first supporting element 211. A second end of the wheel swing member 24 is partially received in a notch 2121 of the second supporting element 212. That is, both terminals of the wheel swing member 24 are connected with the first supporting element 211 and the second supporting element 212, respectively. In such manner, the wheel swing member 24 could be swung with respect to the base 21.

The wheel swing member 24 is disposed on the base 21. The first extension arm 241 of the wheel swing member 24 is disposed over the first tilt switch 261. The second extension arm 242 of the wheel swing member 24 is disposed over the second tilt switch 262. The protrusion 243 is disposed over the wheel switch 263. In this embodiment, the first extension arm 241, the second extension arm 242 and the protrusion 243 are integrally formed with the wheel swing member 24. As shown in FIG. 4, the encoder 22 is accommodated within the receptacle 232, and the rotating shaft 231 penetrates through the encoder perforation 221 of the encoder 22. In a case that the scroll wheel 27 is rotated forwardly (in the direction F) or backwardly (in the direction B), the rotating shaft 231 is driven to rotate in the encoder perforation 221, and thus the encoder 22 generates a corresponding wheel rotation signal. The encoder holder 25 is connected with the wheel swing member 24 through the connecting part 251. By the encoder holder 25, the encoder 22 is fixed within the receptacle 232. The signal wire 29 penetrates through the encoder holder hole 252. A first end of the signal wire 29 is connected to the encoder 22. A second end of the signal wire 29 is connected to the circuit board 28. The wheel rotation signal generated by the circuit board 28. In response to the wheel rotation signal, a vertical scrolling function of the scroll wheel 27 is executed.

Please refer to FIGS. 2, 4 and 5 again. In a case that the scroll wheel 27 is tilted toward the left side (in the direction L), the wheel swing member 24 is swung toward the left side with respect to the base 21. At the same time, the first tilt switch 261 is touched by the first extension arm 241, so that the first tilt switch 261 generates a first tilt signal to the circuit board 28. In response to the first tilt signal, the graphic-based window or the web page shown on the computer screen of the computer (not shown) that is connected to the wheel mouse 2 is horizontally scrolled in the left direction.

In a case that the scroll wheel 27 is tilted toward the right side (in the direction R), the wheel swing member 24 is swung toward the right side with respect to the base 21. At the same time, the second tilt switch 262 is touched by the second extension arm 242, so that the second tilt switch 262 generates a second tilt signal to the circuit board 28. In response to the second tilt signal, the graphic-based window or the web page shown on the computer screen of the computer (not shown) is horizontally scrolled in the right direction.

In a case that the scroll wheel 27 is pressed down (in the direction D), the wheel swing member 24 is moved downwardly toward the base 21. Since the wheel swing member 24 could partially penetrate through the second board hole 282 when the wheel swing member 24 is moved downwardly toward the base 21, the movement of the wheel swing member 24 is not hindered by the circuit board 28. At the same time, the wheel switch 263 is touched by the protrusion 243, so that the wheel switch 263 generates a wheel button signal to the circuit board 28. In response to the wheel button signal, the wheel button function of the wheel mouse 2 is enabled.

From the above description, since the encoder 22 of the wheel mouse 2 is accommodated within the receptacle 232 of the wheel supporting frame 23, the space within the mouse case is reduced. That is, the wheel mouse of the present invention has the functions of a slim wheel mouse and a tilt wheel mouse.

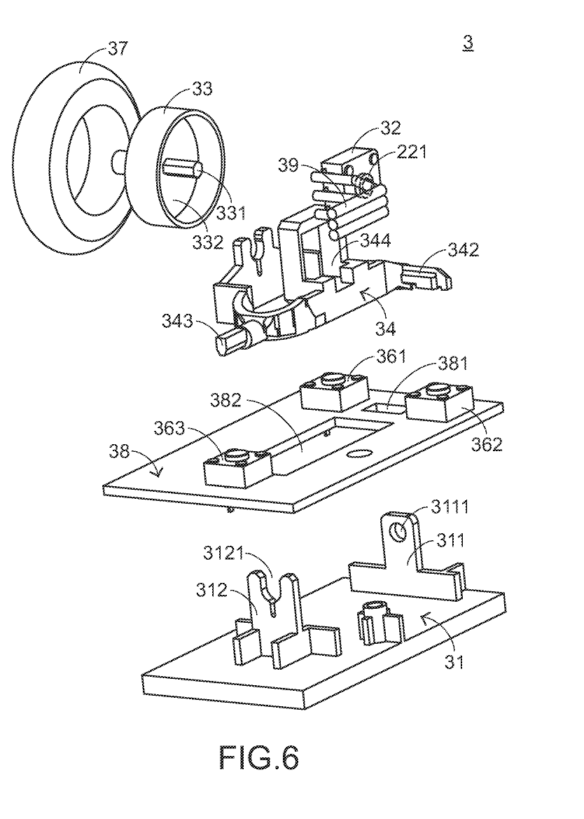

FIG. 6 is a schematic exploded view illustrating the internal portion of the wheel mouse according to a second embodiment of the present invention. As shown in FIG. 6, the wheel mouse 3 comprises a base 31, an encoder 32, a wheel supporting frame 33, a scroll wheel 37, a wheel swing member 34, an encoder holder 344, a circuit board 38, a first tilt switch 361, a second tilt switch 362, a wheel switch 363 and a signal wire 39. In comparison with the first embodiment, the wheel swing member 34 and the encoder holder 344 of the wheel mouse 3 of this embodiment are integrally formed. The configurations and functions of other components included in the wheel mouse 3 of FIG. 6 are similar to those of the first embodiment, and are not redundantly described herein.

According to the practical requirements, the user could select the wheel mouse of the first embodiment or the wheel mouse of the second embodiment. From the above description, it is found that the overall volume of the wheel mouse of the present invention is reduced. In particular, the wheel mouse of the present invention is slim while maintaining the function of the tilt wheel mouse.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wheel mouse comprising:
a base having a first supporting element and a second supporting element;
a circuit board disposed on said base;
a first tilt switch disposed on a first side of said circuit board;
an encoder having an encoder perforation;
a wheel supporting frame comprising a rotating shaft and a receptacle, wherein said rotating shaft penetrates through said encoder perforation, and said encoder is accommodated within said receptacle;
a wheel swing member disposed on said base for accommodating said wheel supporting frame and permitted to be swung with respect to said base, wherein a first end of said wheel swing member is connected to said first supporting element, a second end of said wheel swing member is connected to said second supporting element, and said wheel swing member has a first extension arm arranged above said first tilt switch; and
an encoder holder connected to said wheel swing member for fixing said encoder,
wherein when said wheel swing member is swung with respect to said base and said first tilt switch is touched by said first extension arm, said first tilt switch is triggered to generate a first tilt signal to said circuit board.

2. The wheel mouse according to claim 1 further comprising a scroll wheel, which is disposed on an outer periphery of said wheel supporting frame, wherein said wheel supporting frame is synchronously rotated upon rotation of said scroll wheel.

3. The wheel mouse according to claim 1 wherein said encoder holder comprises a connecting part, and said encoder holder is connected with said wheel swing member through said connecting part.

4. The wheel mouse according to claim 1 wherein said encoder holder and said wheel swing member are integrally formed.

5. The wheel mouse according to claim 1 further comprising a signal wire, wherein a first end of said signal wire is connected to said encoder, a second end of said signal wire is connected to said circuit board, and a wheel rotation signal generated when said wheel supporting frame is transmitted from said encoder to said circuit board through said signal wire.

6. The wheel mouse according to claim 5 wherein said encoder holder further comprises an encoder holder hole, and said signal wire penetrates through said encoder holder hole such that said second end of said signal wire is connected to said circuit board.

7. The wheel mouse according to claim 1 further comprising a second tilt switch and a wheel switch, wherein said wheel switch is disposed on said circuit board, and said second tilt switch disposed on a second side of said circuit board.

8. The wheel mouse according to claim 7 wherein said wheel swing member further comprises:
a second extension arm arranged above said second tilt switch, wherein when said wheel swing member is swung with respect to said base and said second tilt switch is touched by said second extension arm, said second tilt switch is triggered to generate a second tilt signal to said circuit board; and
a protrusion arranged above said wheel switch, wherein when said wheel swing member is moved downwardly toward said base and said wheel switch is touched by said protrusion, said wheel switch is triggered to generate a wheel button signal to said circuit board.

9. The wheel mouse according to claim 8 wherein said circuit board further comprises a first board hole and a second board hole, said first supporting element penetrates through said first board hole, said second supporting element penetrates through said second board hole, and said wheel swing member partially penetrates through said second board hole when said wheel swing member is moved downwardly toward said base.

10. The wheel mouse according to claim 1 wherein said first supporting element has a perforation and said second supporting element has a notch, wherein said first end of said wheel swing member penetrates through said perforation of said first supporting element and said second end of said wheel swing member is partially received in said notch of said second supporting element, so that said wheel supporting frame is permitted to be swung with respect to said base.
